(19) United States
(12) Patent Application Publication
(10) Pub. No.: US 2002/0105930 A1
(43) Pub. Date: Aug. 8, 2002

(54) Combination WDCT and HomeRF air interface

(75) Inventors: Uwe Sydon, Duesseldorf (DE); Juergen Kockmann, Duesseldorf (DE)

Correspondence Address: Siemens Corporation, Intellectual Property Department, 186 Wood Avenue South, Iselin, NJ, 08830, US

(73) Assignee: Siemens Information and Communication Products, LLC

(21) Appl. No.: 09/777,268

(22) Filed: Feb. 5, 2001

(51) Int. Cl. H04J 3/00

(52) U.S. Cl. 370/337; 370/347

(57) ABSTRACT

A cordless communication system employing an air interface capable of providing both isochronous (e.g., voice) and asynchronous (e.g., data) communication is described. The air interface combines advantages of the HomeRF SWAP and WDCT protocols to provide high quality voice and data service without unnecessarily increasing the complexity of the cordless communication system.

### BACKGROUND OF THE INVENTION

1. Field of the Invention

The present invention relates generally to cordless communication systems suitable for use in wireless local area networks and the like, and more particularly to an air interface for a cordless communication system capable of both isochronous (e.g., voice) and asynchronous (e.g., data) communication.

2. Description of the Related Art

In the past, cordless communication systems suitable for use in the home or office have been predominately designed to support voice applications, while support of data applications was provided by independent wireless local area network (LAN) systems which did not provide voice service. However, the wide spread use of the Internet, Intranets, and the like in the home and office has made it highly desirable to provide cordless communication systems that also support data applications. Thus, it is likely that future cordless communication systems will integrate both voice and data services into a single network making both available throughout the home or office.

Such cordless communication systems will require an air interface that has the capacity to provide high quality voice and data service in a cost-effective way. However, the requirements of air interfaces supporting voice and data services are very different. Voice traffic is isochronous and sensitive to delays in transmission while data traffic is asynchronous and relatively insensitive to such delays. Consequently, air interfaces providing voice service have traditionally adopted a different access mechanism than those providing data service. In particular, air interfaces complying with the HomeRF Working Group's Shared Wireless Access Protocol (SWAP) employ a CSMA/CA (Carrier Sense Multiple Access/Collision Avoidance) access mechanism for transmission of data, but lack the interference avoidance capabilities necessary for providing high quality voice service. Conversely, air interfaces complying with the Worldwide Digital Cordless Communications (WDCT) protocol provide exceptional interference avoidance characteristics well suited for voice service. However, because these air interfaces employ a TDMA (Time Division Multiple Access) access mechanism they typically do not handle data as efficiently as air interfaces employing CSMA/CA access mechanisms.

Consequently, it is desirable to provide an air interface for a cordless communication system providing the advantages of the HomeRF SWAP and WDCT protocols so that the air interface is capable of providing both isochronous and asynchronous communication without reducing the quality of either service, and without unnecessarily increasing the complexity of the cordless communication system by which it is employed.

### SUMMARY OF THE INVENTION

Accordingly, the present invention is directed to an air interface for a cordless communication system that is capable of supporting communication of both isochronous (e.g., voice) and asynchronous (e.g., data) information. The air interface combines advantages of the HomeRF SWAP and WDCT protocols to furnish high quality voice and data service to users of the cordless communication system.

In accordance with a first aspect of the invention, a cordless communication system capable of providing both voice and data service is described. The cordless communication system is comprised of a plurality of devices that are capable of wireless communication via an air interface employing a frame structure suitable for transmission of asynchronous information using the HomeRF SWAP protocol and isochronous information using the WDCT protocol. In exemplary embodiments of the invention, if voice service is provided between devices of the system, the frame structure of the air interface is formatted to include at least one WDCT time slot suitable for communicating isochronous information according to the WDCT protocol. However, if voice service is not provided, the frame structure is formatted to include a WDCT control channel or “dummy bearer” suitable for synchronizing devices of the cordless communication using voice service, while allowing a greater amount of the frame to be allotted to transmission of asynchronous information so that the data throughput of the system may be maximized.

In accordance with a second aspect of the invention, a method for providing wireless voice and data service for communication of information between devices of a cordless communication system is described. The method includes the steps of determining if voice service is required by devices in the cordless communication system, and thereafter transmitting at least one frame of the information being communicated wherein each frame is appropriately formatted for transmission of asynchronous information using a HomeRF SWAP protocol and/or isochronous information using the WDCT protocol. In exemplary embodiments of the invention, if no voice service is required, each frame transmitted includes a WDCT control channel or “dummy bearer” suitable for synchronizing devices of the cordless communication requiring voice service, while allowing a greater amount of the frame to be allotted to transmission of asynchronous information. However, if voice service is required, each frame transmitted is formatted to include at least one time slot suitable for communicating isochronous information according to the WDCT protocol.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 is a block diagram illustrating a cordless communication system capable of employing an air interface in accordance with an exemplary embodiment of the present invention;

FIGS. 2 and 3 are schematic diagrams illustrating the structure of exemplary frames of air interfaces in accordance with the present invention, wherein the frames permit transmission of both asynchronous and isochronous information;

FIG. 4 is a schematic diagram illustrating the structure of an exemplary frame of an air interface in accordance with the present invention, wherein the frame permits transmission of asynchronous information only; and

FIG. 5 is a flow diagram illustrating an exemplary method suitable for use by the cordless communication system shown in FIG. 1 for transmitting information using the air interface of the present invention.

### DETAILED DESCRIPTION OF THE INVENTION

The present invention provides an air interface for a cordless communication system that is capable of supporting both isochronous (e.g., voice) and asynchronous (e.g., data) communication. The air interface combines advantages of the HomeRF SWAP and WDCT protocols to provide high quality voice and data service without unnecessarily increasing the complexity of the cordless communication system by which it is employed. The air interface further allows components intended for use in systems employing either protocol individually to be reused in the design and manufacture of devices of cordless communication system capable of providing both voice and data service, thereby providing a substantial cost advantage. Reference will now be made in detail to the presently preferred embodiments of the invention, examples of which are illustrated in the accompanying drawings.

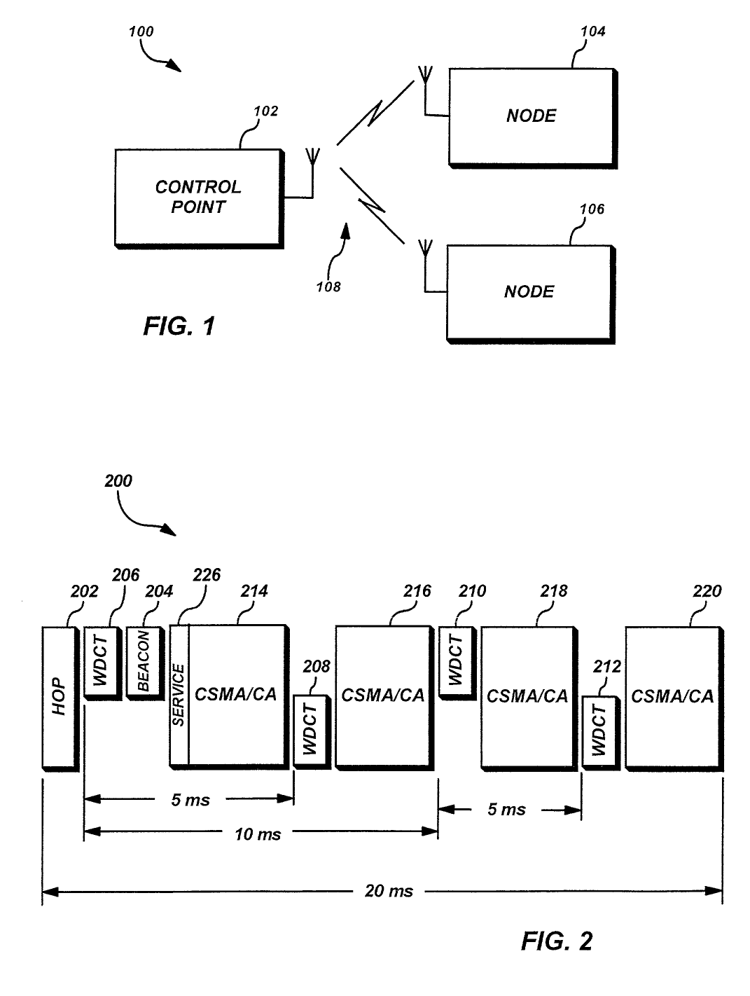

Referring now to FIG. 1, a cordless communication system employing an air interface in accordance with an exemplary embodiment of the present invention is described. The cordless communication system 100 is comprised of two or more devices 102, 104 & 106 forming nodes of wireless local area network (LAN) 108. Generally, local area network 108 operates as a managed network, wherein a first device 102 of the cordless communication system 100 functions as a “control point” for supporting voice and data service with devices 104 & 106 forming other nodes of the wireless local area network 108. In embodiments of the invention, devices 104, & 106 may provide any of a number of different types of nodes within network 108, including, but not limited to, voice nodes supporting voice service with the control point, data nodes supporting data service with the control point or other data nodes, and combination voice and data nodes supporting both voice and data service. The control point device 102 may manage access to the network 108 by other devices 104 & 106 of the cordless communication system 100, and may provide an interface between these devices 104 & 106 and external networks such as a public switched telephone network (PSTN), an integrated services digital network (ISDN), the Internet, an Intranet, or the like for communicating with devices outside of wireless local area network 108.

In exemplary embodiments of the invention, devices 102, 104 & 106 may employ frequency hopping spread spectrum (FHSS) radio technology and operate at a frequency in the 2.4 GHz ISM (Industrial Scientific Medical) frequency band. The devices 102, 104 & 106 utilize an air interface having a frame structure suitable for transmission of asynchronous information using the HomeRF SWAP protocol and isochronous information using the WDCT protocol. The air interface thus combines both TDMA and CSMA/CA access mechanisms to provide high quality voice and data service to users of the cordless communication system 100. In this manner, the air interface of the present invention allows devices 102, 104 & 106 to operate in the presence of other ISM band radio systems, and other interference sources such as microwave ovens, heavy machinery, and the like.

In exemplary embodiments of the invention, the frame structure of the air interface uses a dwell period of 20 ms employing two bit rates 1 Mb/s using 2FSK (Frequency Shift Keying) modulation and 2 Mb/s using 4FSK modulation. The frame structure may be formatted differently depending on whether voice service is requested by devices 102, 104 & 106 in the communication system 100. If voice service is provided, the frame structure is formatted to include at least one time WDCT time slot suitable for communicating isochronous information according to the WDCT protocol. However, if voice service is not provided, the frame structure of the air interface includes a WDCT control channel or “dummy bearer” suitable for synchronizing devices of the cordless communication using voice service. Preferably, during the period of time wherein the WDCT control channel or a WDCT time slot is transmitted, the cordless communication system changes its carrier frequency from the SWAP carrier frequency to a WDCT carrier frequency. Further, during such periods the system also utilizes a WDCT bandwidth and bit duration instead of the SWAP bandwidth and bit duration.

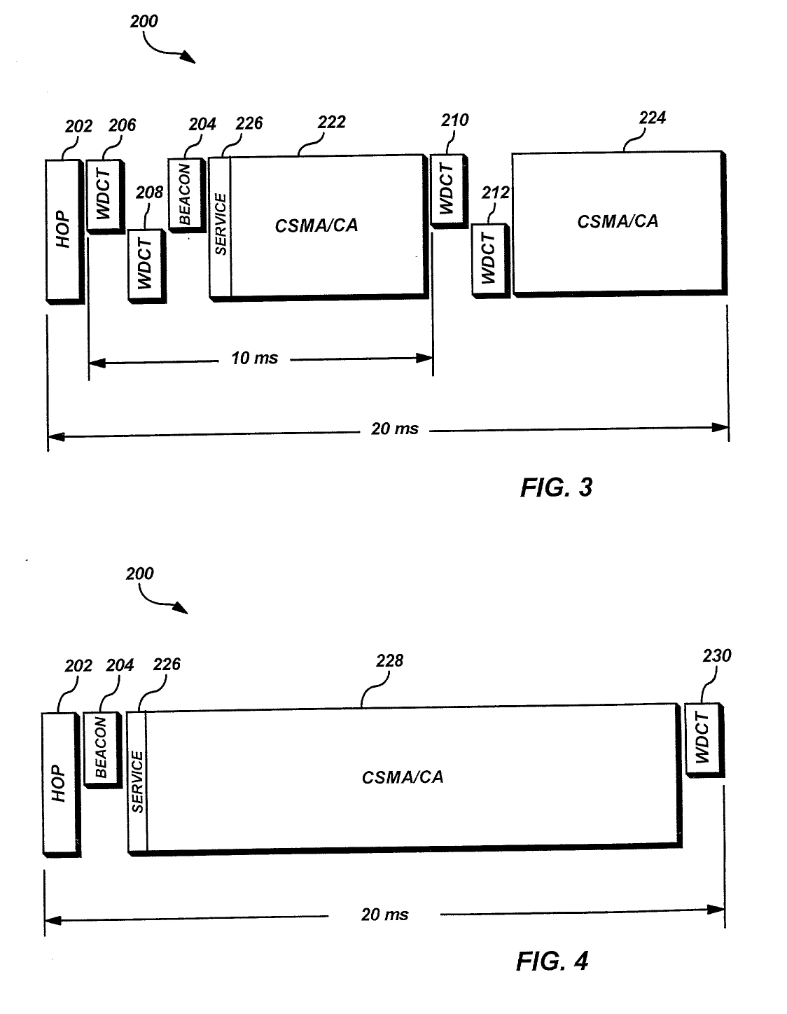

Exemplary frame structures formatted for communication of both asynchronous and isochronous information in accordance with the present invention are shown in FIGS. 2 and 3. Each frame 200 includes a hop command 202, a SWAP beacon 204, and a plurality of fixed length WDCT time slots 206, 208, 210 & 212 interspersed among SWAP periods 214, 216, 218, 220, 222 & 224. The frame 200 is initiated at the hop command 202 wherein the nodes communicating via the air interface hop to the channel used by the frame 200 and is terminated immediately before the nodes hop to the next channel. Preferably, the duration of the frame 200 is fixed and is the same as the dwell or hop period, i.e., the period between the start of one hop command 202 and the next. In the present air interface, this period is approximately 20 ms.

The WDCT time slots 206, 208, 210 & 212 are paired into sets capable of providing one or more contention free voice connections between the control point of the wireless local area network and voice service capable nodes of the network. Each set includes a WDCT transmit slot or downlink 206 & 210 for transmitting isochronous information from the control point to a node of the network, and a WDCT receive slot or uplink 208 & 212 for transmitting isochronous information from a node of the network to the control point. Preferably, a first WDCT transmit (downlink) time slot 206 is transmitted immediately after the hop command 202, i.e., immediately after system hops to a new channel. A second WDCT transmit slot 210 may then be transmitted within the frame 200 after a period of 10 ms. A paired WDCT receive slot 208 & 212 is then transmitted after each WDCT transmit slot 206 & 210. In one embodiment, shown in FIG. 2, each WDCT receive slot 208 & 212 may be transmitted after a period of approximately 5 ms following transmission of its corresponding WDCT transmit slot 206 & 210. Alternately, as shown in FIG. 3, each WDCT receive slot 208 & 212 may be transmitted immediately after each WDCT transmit slot 206 & 210 without a delay period.

Asynchronous (e.g., data) information is transmitted during periods 214, 216, 218, 220, 222 & 224 using a CSMA/CA access mechanism in accordance with the HomeRF SWAP protocol. Preferably, these SWAP periods 214, 216, 218, 220, 222 & 224 employ a slotted contention scheme, allow for acknowledgment and retransmission of data messages, and utilize a fragmentation scheme to improve performance as specified by the HomeRF SWAP protocol. As shown in FIG. 2, wherein a 5 ms period separates each WDCT transmit slot 206 & 210 from its respective WDCT receive slot 208 & 212, four SWAP periods 214, 216, 218 & 220 are provided within frame 200, wherein a first SWAP period 214 occupies the space between SWAP beacon 204 and first WDCT receive slot 208, a second SWAP period 216 occupies the space between first WDCT receive slot 208 and second WDCT transmit slot 210, a third SWAP period 218 occupies the space between second WDCT transmit slot 210 and second WDCT receive slot 212, and a fourth SWAP period 220 occupies the space between the second WDCT receive slot 212 and the end of the frame 200. Alternately, as shown in FIG. 3, wherein each WDCT receive slot 208 & 212 immediately follows its corresponding WDCT transmit slot 206 & 210, two SWAP periods 222 & 224 provided: a first SWAP period 222 occupying the space between SWAP beacon 204 and second WDCT transmit slot 210, and a second SWAP period 224 occupying the period between second WDCT receive slot 212 and the end of the frame 200.

The SWAP beacon 204 is transmitted immediately after the first WDCT transmit slot 206. In accordance with the HomeRF SWAP protocol, the beacon 204 may be used to maintain network synchronization by enabling all nodes to synchronize to the hopping pattern of the network The beacon 204 may further control the format of the frame, and manage when each node should transmit and receive information. In embodiments of the invention, the beacon 204 may also include a list of active voice connections and time slot assignments, retransmission time slot assignments for the current frame, connection status information, and paging information. For instance, if voice service is requested, the control point uses beacon 204 to inform other nodes in the network and will reserve appropriate WDCT transmit and receive slots 206, 208, 210 & 212 for the voice connection.

As shown in FIGS. 2 and 3, a service slot 226 is reserved at the beginning of the first SWAP period 214 (FIG. 2) or 222 (FIG. 3) in frame 200. The service slot 226 may be used by network nodes for communicating with the control point. For instance, in exemplary embodiments of the invention, the service slot 226 may be used by data service capable nodes to send management messages to the control point, e.g., to request a connection from the control point or the like. Preferably, each management message transmitted is acknowledged by the control point in the SWAP beacon 204. If a node, transmitting a management message in service slot 226, does not receive acknowledgment of the message in beacon 204, it performs a random back off across a number of dwell periods before resending the message. In this manner, if two nodes transmit at the same time and their transmissions collide each node is made to resend its original management message at a randomly spaced time.

To optimize the performance of the air interface, the control point may eliminate any unused WDCT time slots and increase the amount of frame 200 allotted to SWAP periods for transmission of asynchronous information. In this manner, the control point may maximize data throughput within the cordless communication system. An exemplary frame formatted for transmission of asynchronous information when voice service is not used is shown in FIG. 4. The frame 200 includes hop command 202, SWAP beacon 204, a SWAP period 228 comprising a contention period suitable for transmission of asynchronous information, and the WDCT control channel or “dummy bearer” 230. As before, the frame 200 is initiated at the hop command 202 and is terminated immediately before the hop to the next channel. Preferably, the duration of the frame 200 is again fixed and is the same as the dwell or hop period, i.e., approximately 20 ms. Since there is no voice connection active, the SWAP period 228 occupies the whole of the frame 200, with the exception of the space required for the hop command 202, the SWAP beacon 204 and the WDCT control channel 230 thus maximizing the data throughput of the communication system.

In exemplary embodiments of the invention, the WDCT control channel 230 is used by voice service capable nodes in the network to synchronize to the control point when no voice connections are active. The WDCT control channel 230 may also be used by the control point for signaling nodes, such as mobile cordless telephones and the like, that a telephone call has been received and voice service is required. Further, the WDCT control channel 230 may be used by voice capable nodes of the system to request a voice connection with the control point. When closing a voice connection, the node may then transmit a management message to the control point requesting that the voice connection be terminated during a WDCT receive (uplink) slot 208 & 212.

It will be appreciated, based on the foregoing discussion, that additional WDCT time slots may be provided within frame 200 to allow for further voice connections. In accordance with the HomeRF SWAP and WDCT protocols, the frame structure of the present air interface may be modified to include up to two additional sets of WDCT transmit and receive slots thereby supporting up to four simultaneous voice connections. However, in providing these additional WDCT time slots, the amount of the frame 200 allotted to SWAP periods for providing asynchronous communication is correspondingly decreased, reducing the data throughput of the system.

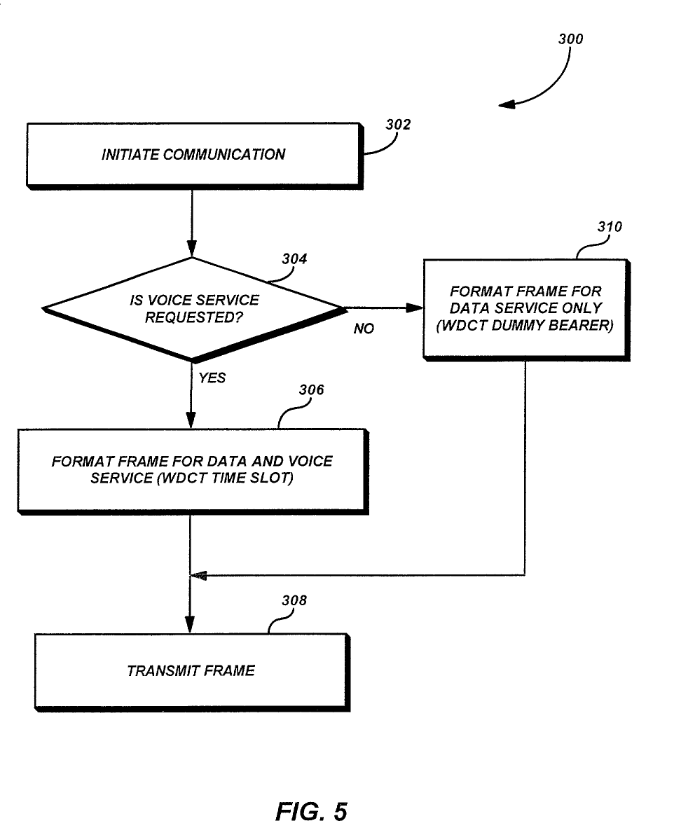

Referring now to FIG. 5, a flow diagram illustrating an exemplary method suitable for use by the cordless communication system 100 shown in FIG. 1 for providing voice and data service using the air interface of the present invention is described. As shown in FIG. 5, when communication is initiated between devices of the cordless communication system, at step 302, a determination is first made, at step 304, whether voice service is to be provided, i.e., whether isochronous information is to be communicated between the devices. If voice service is requested, the frame structure is formatted, as shown in FIGS. 2 and 3, to include at least one WDCT time slot suitable for communicating isochronous information according to the WDCT protocol, at step 306. Both asynchronous and isochronous information may then be communicated, at step 308, wherein asynchronous information is transmitted using a CSMA/CA access mechanism according to the HomeRF SWAP protocol and isochronous (voice) is transmitted using a TDMA access mechanism according to the WDCT protocol. If, on the other hand, voice service is not provided, the frame structure of the air interface is formatted, as shown in FIG. 4, to include a WDCT control channel or “dummy bearer” at step 310. Asynchronous (data) information may then be communicated between devices of the cordless communication system at step 308, using a CSMA/CA access mechanism in accordance with the HomeRF SWAP protocol. Preferably, during the period of time wherein the WDCT control channel or a WDCT time slot is transmitted, the cordless communication system will change its carrier frequency from the SWAP carrier frequency to a WDCT carrier frequency and utilize a WDCT bandwidth and bit duration instead of the SWAP bandwidth and bit duration.

In exemplary embodiments, the various steps of method 300 may be implemented as sets of instructions such as software or firmware implemented in one or more devices 102, 104 & 106 of cordless communication system 100 shown in FIG. 1. It is to be understood that the specific order or hierarchies of steps in the method 300 are examples of exemplary approaches. Based upon design preferences, it is contemplated that the specific order or hierarchy of steps in the method can be rearranged while remaining within the scope of the present invention. The attached method claims present elements of the various steps in a sample order, and are not meant to be limited to the specific order or hierarchy presented.

It is believed that the cordless communication system of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A cordless communication system capable of providing voice and data service, comprising:
a first device; and
a second device capable of wireless communication with said first device via an air interface;
wherein the air interface employs a frame structure suitable for communication of asynchronous information using a HomeRF SWAP protocol and isochronous information using a WDCT protocol.

2. The cordless communication system of claim 1, wherein the frame structure includes at least one WDCT time slot suitable for communicating the isochronous information if voice service is requested.

3. The cordless communication system of claim 2, wherein the air interface utilizes a WDCT carrier frequency, bandwidth and bit duration while the at least one WDCT time slot is transmitted.

4. The cordless communication system of claim 2, wherein the at least one WDCT time slot comprises a WDCT transmit slot and a WDCT receive slot, the WDCT receive slot directly following the WDCT transmit slot in the frame structure.

5. The cordless communication system of claim 2, wherein the at least one WDCT time slot comprises a WDCT transmit slot and a WDCT receive slot, the WDCT transmit slot being followed by the WDCT receive slot after approximately 5 ms.

6. The cordless communication system of claim 1, wherein the frame structure includes a WDCT control channel suitable for controlling devices of the cordless communication using voice service when no voice service is requested.

7. The cordless communication system of claim 6, wherein the air interface utilizes a WDCT carrier frequency, bandwidth and bit duration while the WDCT carrier channel is transmitted.

8. The cordless communication system of claim 1, wherein, if no isochronous information is to be transmitted within the frame structure, the frame structure is formatted to include in order a hop command, a beacon, a SWAP period suitable for transmission of asynchronous information, and a WDCT control channel suitable for controlling devices of the cordless communication system using voice service.

9. The cordless communication system of claim 1, wherein, if isochronous information is to be transmitted within the frame structure, the frame structure is formatted to include in order a hop command, a first WDCT transmit slot, a beacon, a first SWAP period, a first WDCT receive slot, a second SWAP period, a second WDCT transmit slot, a third SWAP period, a second WDCT receive slot, and a fourth SWAP period, the SWAP periods being suitable for transmission of asynchronous information using a CSMA/CA access mechanism according to the HomeRF SWAP protocol and the WDCT transmit and receive slots being suitable for transmission of isochronous information using a TDMA access mechanism according to the WDCT protocol.

10. The cordless communication system of claim 9, wherein the first WDCT transmit slot precedes the first WDCT receive slot by approximately 5 ms, the second WDCT transmit slot precedes the second WDCT receive slot by approximately 5 ms, and the first WDCT transmit slot precedes the second WDCT transmit slot by approximately 10 ms.

11. The cordless communication system of claim 1, wherein, if isochronous information is to be transmitted within the frame structure, the frame structure is formatted to include in order a hop command, a first WDCT transmit slot, a first WDCT receive slot, a beacon, a first SWAP period, a second WDCT transmit slot, a second WDCT receive slot, and a second SWAP period, the SWAP periods being suitable for transmission of asynchronous information using a CSMA/CA access mechanism according to the HomeRF SWAP protocol and the WDCT transmit and receive slots being suitable for transmission of isochronous information using a TDMA access mechanism according to the WDCT protocol.

12. A cordless communication system capable of providing voice and data service, comprising:
a first device; and
a second device capable of wireless communication with said first device via an air interface employing a frame structure suitable for transmission of asynchronous information utilizing a HomeRF SWAP protocol;
wherein, if voice service is provided between said first device and said second device, the frame structure further includes at least one time slot suitable for communicating isochronous information utilizing a WDCT protocol; and
wherein, if voice service is not provided between said first device and said second device, the frame structure further includes a WDCT control channel suitable for controlling devices of the cordless communication system requiring voice service.

13. The cordless communication system of claim 12, wherein the WDCT control channel is disposed at the end of the frame structure.

14. The cordless communication system of claim 12, wherein the air interface utilizes a WDCT carrier frequency, bandwidth and bit duration while the at least one WDCT time slot and the WDCT control channel are transmitted.

15. The cordless communication system of claim 12, wherein the at least one WDCT time slot comprises a WDCT transmit slot and a WDCT receive slot, the WDCT receive slot directly following the WDCT transmit slot in the frame structure.

16. The cordless communication system of claim 12, wherein the at least one WDCT time slot comprises a WDCT transmit slot and a WDCT receive slot, the WDCT transmit slot being followed by the WDCT receive slot after approximately 5 ms.

17. A method of providing voice and data service for communication of information in a cordless communication system, comprising:
determining if voice service is required; and
communicating at least one frame of the information being communicated, the at least one frame having a frame structure suitable for transmission of asynchronous information using a HomeRF SWAP protocol and isochronous information using a WDCT protocol;
wherein, if no voice service is required, the frame structure includes a WDCT control channel suitable for controlling devices of the cordless communication system requiring voice service; and
wherein, if voice service is required, the frame structure includes at least one WDCT time slot suitable for communicating isochronous information.

18. The method as claimed in claim 17, further comprising altering the carrier frequency of the air interface from a SWAP carrier frequency to a WDCT carrier frequency when at least one of a WDCT control channel and a WDCT time slot are transmitted.

19. The method as claimed in claim 17, further comprising altering the bandwidth of the air interface from a SWAP bandwidth to a WDCT bandwidth when at least one of a WDCT control channel and a WDCT time slot are transmitted.

20. The method as claimed in claim 17, further comprising altering the bit rate of the air interface from a SWAP bit rate to a WDCT bit rate when at least one of a WDCT control channel and a WDCT time slot are transmitted.

21. The method as claimed in claim 17, wherein transmitting at least one frame suitable for containing data information further comprises transmitting the WDCT control channel at the end of each frame.

22. The method as claimed in claim 21, wherein transmitting the WDCT dummy bearer at the end of the SWAP frame structure comprises transmitting the WDCT control channel approximately every 20 ms.

23. The method as claimed in claim 17, wherein the at least one WDCT time slot comprises a WDCT transmit slot and a WDCT receive slot, the WDCT receive slot directly following the WDCT transmit slot in the frame structure.

24. The method as claimed in claim 17, wherein the at least one WDCT time slot comprises a WDCT transmit slot and a WDCT receive slot, the WDCT transmit slot being followed by the WDCT receive slot after approximately 5 ms.
